(19) United States
(12) Patent Application Publication
(10) Pub. No.: US 2012/0310699 A1
(43) Pub. Date: Dec. 6, 2012

(54) APPROACH AND TOOL BLENDING AD-HOC AND FORMAL WORKFLOW MODELS IN SUPPORT OF DIFFERENT STAKEHOLDER NEEDS

(75) Inventors: Monica McKenna, North Berwick, ME (US); Roberto Silveira Silva Filho, Lawrenceville, NJ (US); Kevin McDevitt, Collegeville, PA (US)

(73) Assignee: Siemens Corporation, Iselin, NJ (US)

(21) Appl. No.: 13/442,137

(22) Filed: Apr. 9, 2012

Related U.S. Application Data
(60) Provisional application No. 61/492,419, filed on Jun. 2, 2011.

(51) Int. Cl. G06Q 10/06

(52) U.S. Cl. 705/7.26

(57) ABSTRACT

A flexible project management workflow uses a flexible process model that supports structured, unstructured and semi-structured workflow execution. The model combines formal models with data triggers and spontaneously triggered action items that may be added ad hoc by approvers or actors involved in the workflow. The model makes use of Web-based implementation, automatic tracking of data evolution and e-mail notifications as usability components.

### CROSS REFERENCE TO RELATED APPLICATIONS

This application claims the benefit of U.S. Provisional Application Ser. No. 61/492,419 entitled “Approach and Tool Blending Ad-Hoc and Formal Workflow Models in Support of Multiple Stakeholder Needs,” filed on Jun. 2, 2011, the contents of which are hereby incorporated by reference herein in their entirety.

### FIELD OF THE INVENTION

This invention relates generally to managing the workflow of a data item through an organization, and more particularly to methods, systems and computer readable media for managing workflow by blending ad-hoc workflow models with formal workflow models.

### BACKGROUND OF THE INVENTION

Workflow Management Systems (WfMSs), also known as Business Process Management Systems (BPMSs), employ process representations involving tasks, people and activities in the automation or coordination of activities. One goal of WfMSs is to reduce the burden of coordinating a given task by automating the task of collecting and disseminating information required for the task. Another important benefit of these systems is the ability to track, report on, and monitor existing process instances, and data items associated to them, supporting activities such as management and auditing of complex processes.

Initial office process automation tools and approaches were not very successful. Common problems included excessive process specification, inappropriate handling of exceptions, poor user interface designs, and divergences between the ways work is actually done versus how it was specified. More recent experience in the use and development of these systems in organizational settings has resulted in the proposal of more flexible workflow definition languages and automation approaches.

More recently, WfMSs have been adopted in many organizations in the form of Enterprise Resource Planning (ERP) systems that automate well-regulated business processes in domains such as health care, accounting and banking. Systems in those categories include SAP, Microsoft Dynamics, Oracle and others. The successful adoption of those systems, however, usually comes with high customization and maintenance costs. Hence, in spite of the availability of such tools, many business processes are therefore still supported by ad-hoc solutions based on spreadsheets, word processing documents and ad-hoc e-mail exchanges. While those ad-hoc approaches are generally cheap and fast to develop, they lack the scalability, reliability and data change management needed by large organizations. Thus, the gap between ad-hoc solutions and the complexity of more formal and scalable ERP systems has created a need for light-weight, cheaper and more flexible approaches that automate business-specific processes at reduced costs.

### SUMMARY OF THE INVENTION

The present invention addresses the needs described above by providing a flexible method for managing a process workflow in an enterprise. The method is executed, at least in part, by a computer. The method comprises presenting an organization-specific workflow template including a plurality of process levels, each process level comprising one or more process steps that must be completed before the process workflow advances to a next process level. For each process step, an identification is received of a selected responsible party by whom the process step must be completed. For a particular process step, a notification is transmitted to the selected responsible party that a process step is due to be completed in the future.

For the particular process step, one or more ad-hoc, steps can be produced. This is called action item. Action item creation commands are produced by any responsible party assigned to a workflow instance. The commands include an action item task definition and an action item responsible actor, and may be produced at any time during a workflow process execution. However, completion of the action item is required before the process workflow is finalized. A notification is transmitted to the action item responsible actor that the action item is due in the future.

### BRIEF DESCRIPTION OF THE DRAWINGS

FIG. 1 is a schematic illustration showing the main approach elements of a change management tool in accordance with one embodiment of the invention.

FIG. 2 is a representation of a database model showing a work item in accordance with one embodiment of the invention.

FIG. 3 is a screenshot of a process rules definition page in accordance with one embodiment of the invention.

FIG. 4 is a diagram of a process workflow in accordance with one embodiment of the invention.

FIG. 5 is a representation of steps in a workflow model in accordance with one embodiment of the invention.

FIG. 6 is a diagram of another process workflow in accordance with one embodiment of the invention.

FIG. 7 is a screenshot of a configuration page in accordance with one embodiment of the invention.

FIG. 8 is a schematic diagram showing operation of a tool in accordance with one embodiment of the invention.

FIG. 9 is a diagram of another process workflow in accordance with one embodiment of the invention.

FIG. 10 is a diagram of another process workflow in accordance with one embodiment of the invention.

FIG. 11 is a diagram of another process workflow in accordance with one embodiment of the invention.

FIG. 12 is a flowchart of a method in accordance with one embodiment of the invention.

FIG. 13 is a schematic diagram showing a computer system for instantiating a tool in accordance with one embodiment of the invention.

### DESCRIPTION OF THE INVENTION

The presently described workflow management system is a flexible project management workflow that bridges the gap between ad-hoc solutions and formal and complex enterprise resource planning systems. That goal is achieved through the use of a flexible process model that supports structured, unstructured and semi-structured workflow execution. An important aspect of the approach is the combination of formal workflow models, enriched with the concept of optional activities, role distribution lists and user defined, spontaneously triggered actions items. The action items are an important flexibility mechanism behind the model. The approach utilizes Web-based implementation, automatic tracking of data evolution and e-mail notifications as basic usability components.

The presently described system was developed to facilitate adoption by large organizations facing two main problems: platform heterogeneity and adaptation costs. Enterprises often have their own versions of enterprise resource planning systems, sometimes provided by outside vendors. Any new system must seamlessly blend with existing enterprise resource planning infrastructures, instead of requiring changes to be made in these systems, thus minimizing the costs of change when the new system put into effect.

Instead of adopting ad-hoc solutions, based, for example, on spreadsheets or home-grown databases developed for each enterprise, the present inventors therefore created a flexible workflow engine that could be integrated with existing enterprise resource planning systems, and which process could be flexible enough to fit the needs of different enterprises and their processes. In addition to interoperability and process flexibility, the following issues were considered:

Need for consistent project information: Workflow process changes are sometimes not tracked appropriately. For example, in some organizations the workflow process change tracking is performed in an ad-hoc manner using spreadsheets and various file shares, which results in inconsistent reports.

Need for workflow history accountability: Histories of workflows (who, why, when, where) are necessary pieces of information required for audits. For example, in a chain of approval workflow, when the approval process is based on emails, faxed documents, and phone calls, it is very difficult to produce proof of the approvals for an audit.

Need for increased workflow state awareness: In current systems, it is difficult to understand the workflow process and it is difficult to see if the process was actually followed. For example, in a particular situation (item, value), who is the person that must approve it? Who else should be informed? When is it OK to pick somebody else? Who else can be picked?

Need for organizational change awareness: Changes to delegations of authority are often painful in current systems. A delegation of authority defines a hierarchy of management, approval and roles of stakeholders. In other words, it defines who must approve a certain type of conformance cost, based on its value, for example. As with any hierarchy, a delegation of authority changes over time, and requires periodic notifications of organization changes, which was typically performed via emails and process documentation updates that must be distributed to all users.

Need for better user interfaces: People need familiar user interfaces that are based on modem technology and that reflect their workplace terminology and practices. Many older versions of enterprise resource planning systems have outdated user interfaces and employ terminologies that are specific to their systems, as opposed to the user domain. Interfaces should instead fit a broader audience, including not only experts but also non-experts. Putting it in simple terms, current enterprise resource planning systems have interfaces that “do not speak the language of their users.” To address this issue, the inventors have employed a Web interface and e-mail integration.

Need for better means of coordination: People need to coordinate in different situations. For example, when selecting dates for a specific event to occur, both physical resources as well as people availability must be considered. Trying to coordinate this by exchanging emails or by phone calls is very time-consuming and difficult to organize.

Approach

In response to those requirements, an adaptive workflow management approach and a tool implementing that approach were developed. The central goal of the tool is to centralize data, decisions and communication in a flexible workflow management system that can be customized to support the needs of different business units and enterprises.

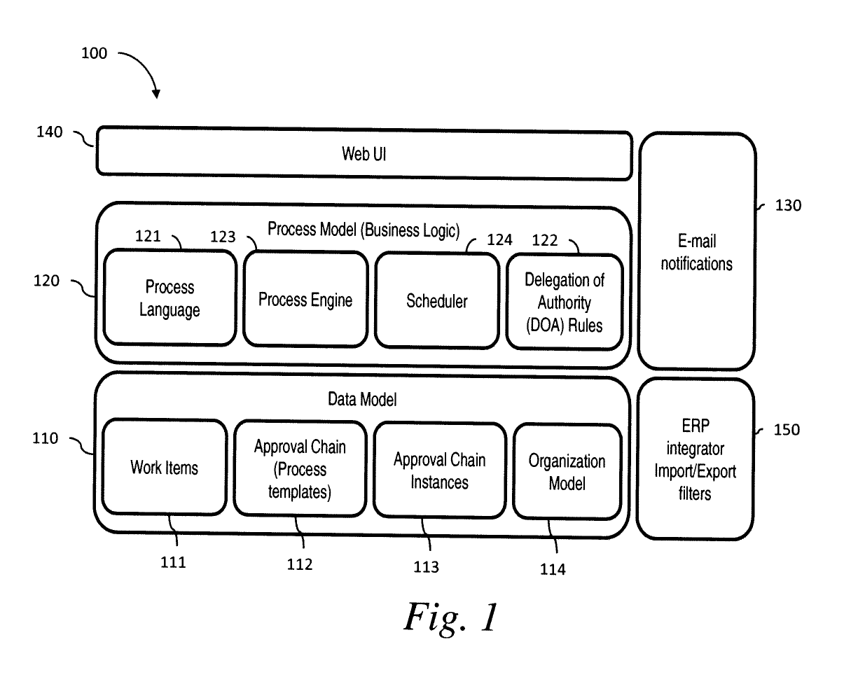

As depicted in FIG. 1, the approach used in creating the change management tool 100 combines a set of elements. The change management tool 100 is described herein with reference to an exemplary approval chain in an organization. One skilled in the art will recognize that the tool is equally applicable to other organizational process workflows, and that the tool may address process steps other than approvals. The tool includes a data model 110, composed of individual work items 111 of different types (non-conformance costs, opportunities, change orders, reconciliations, etc.); and a process model 120 (business logic) that prescribes a process workflow, in this case, it is called a chain of approval, and defines activities that must be performed in the life cycle of each work item, and an organization model that represents the delegation of authority hierarchy, represented by approvers in each role. That allows the process model to be role-based and tied to the organization model. The model is role-based and supports different users in different roles.

The process model 110 and the data model 120 are integrated by means of events and a set of delegation of authority (or other hierarchy) rules 122. When actors modify the content or status of an item, resulting in the evolution of a work item or process step, notifications are produced. Work items and/or approval requests are then sent to their assigned users via e-mail notifications 130, which include a description of the work item nature, status and required action. Finally, the system can periodically remind users to respond to open actions, resulting in reminding e-mail notifications.

The interface 140 between the system and its users is Web-based. From any workstation in the organization, users can configure workflow processes, modify the attributes, query the current status of a work item or process step, locate other relevant items, and generate reports. The Web interface not only supports the ubiquitous use of the system but also supports the users' domain language; for example, it utilizes terms such as chain of approval, work item and delegation of authority.

The flexibility of the system is supported by the data model 110 that stores contextual information about work items/process steps and the process workflow, and a workflow model 120 that accommodates three main usage modes: structured, unstructured (or ad-hoc) and a blended mode. The system automatically captures the process history. Hence, instead of requiring users to explicitly change the workflow model in order to handle exceptions, the presently described system captures the work assignments (action items and optional activities) as they are enacted and/or defined by the users. In that way, the workflow becomes more fluid, not requiring extra restructuring stages. In other words, the process is automatically constructed as work is assigned from one person to another.

From a theoretical standpoint, the presently described approach includes both as “maps” of the organization and “scripts” of the chains of approval a work item/process step must pass through. That information allows users to decide who to request approval from, and what steps to take from a current state. Optional activities can be defined. They are automatically included/excluded from the workflow based on the state or content of a work item. For example, if a work item has a value higher than a threshold, an extra approval step, involving high management, becomes a requirement in a chain of approval. Finally, the approach also supports interactive enactment by means of ad-hoc activities called action items. Action items are tasks that may be spontaneously created by users throughout the life of a process. They can be used to delegate tasks to other users, ask for comments, mark important events of the systems, and so on. Action items support the creation of user-defined workflows, adding an extra layer of flexibility to the system.

From an architectural perspective, one key to the presently described approach is the separation between model and process, and the support for history tracking, organizational modeling and role-based processes. The system workflow model is capable of supporting different types of workflow, ranging from structured to semi-structured and unstructured processes. Hence, instead of requiring users to explicitly change the workflow model in order to handle exceptions, the presently described system captures the work assignments (action items and optional activities) as they are enacted and/or defined by the users. In that way, the workflow becomes more fluid, without requiring extra restructuring stages. In other words, the process is automatically constructed as work is assigned from one person to another.

Compared to existing art, the focus of the presently described approach is not so much on expressing exception handling conditions, but on constructing and recording work as it is performed. The approach is effective in cases ranging from structured to unstructured workflow automation. In the following sections, the elements within the system data model 110, business logic or process model 120 and user interface 140 are described in more detail.

Data Model

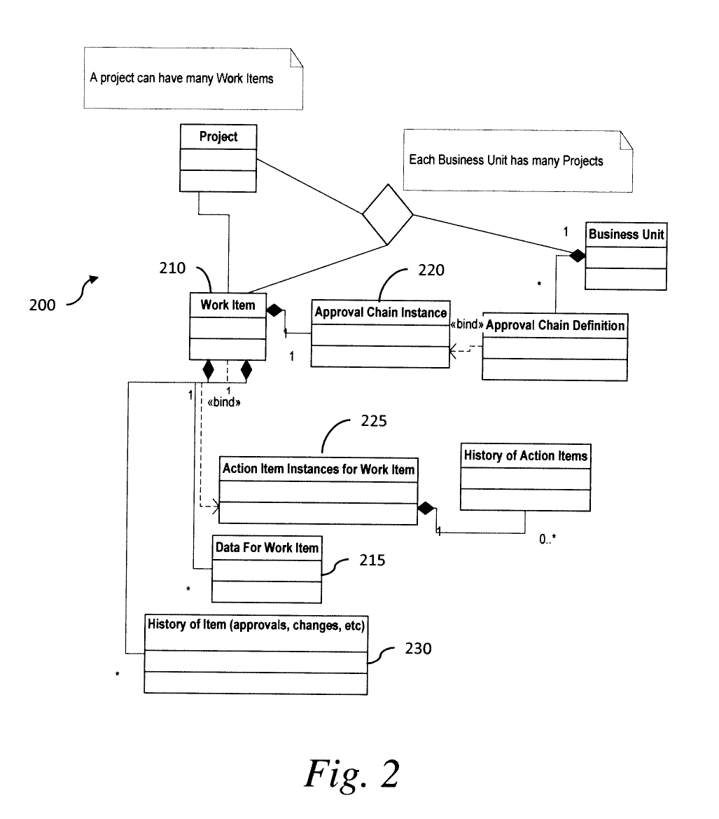

The system data model 110, also shown in detail in FIG. 2, encompasses work items 111, the delegation of authority hierarchy or organizational model 114, workflow templates (approval chains in the illustrated example) 112 and their respective instances 113.

The approval chain or workflow template defines a general workflow defined for each business unit based on roles defined in the delegation of authority. There is usually one general approval chain template per business unit. It defines “fixed parts” and “soft parts.” As such it prescribes a set of steps and stages a work item must satisfy before final approval, together with the role of the user performing each step in this chain. The actual execution of the approval chain may vary, and is recorded in each work item. The roles and the order of activities are fixed. Roles can be optional, but when they are used, any user within that role can be selected for that task. Activities can be dynamically selected based on different item content criteria; for example, total order value, risk, and other attributes may be used.

Work items or process steps, illustrated in a database model 200 in FIG. 2, are the main elements being tracked by the system. Each work item 210 encompasses the data 215 being tracked, a specific instance of the approval chain 220 for the item, action items 225 attached to the item, and its history 230. The specific instance of the approval chain 220 is the actual description of the approval workflow. While there is flexibility in the workflow for a specific work item, the workflow must obey the general bounds.

The presently described system was originally created to support work items/process steps that were non-conformance costs. The set of supported work items has been expanded to represent change orders, risks, opportunities, customer concessions, meeting schedules and other business related data. Each variation of the item has a different set of data fields, and some data fields are given special meaning.

A work item may also be used to represent a scheduling context. In scheduling, the tool is used as a collaborative project coordinator, where the goal is to organize people's coordination on dates and resources, capturing their decisions.

Action Items: Action items are special activities associated with a single work item, and are assigned a responsible user in the system. Action items include a brief description of the work that must be done. From a workflow process point of view, action items are orthogonal to the process instance as they don't impact the workflow template. They impact only the termination of a workflow instance execution. Each workflow instance may have zero or more action items. It is frequently the case that a workflow instance may not be completed until all of its action items are completed.

Events: Events are triggered when users approve items, or when they create or change the status of action items. These events will re-compute the item's status and values, which then may trigger additional data-triggered activities in the workflow instance and generate email notifications as needed.

Contextual data model: The data model provides answers to “who, when, how, where” types of queries. Users are usually interested in a data model that allows the answering of questions involving those subjects. For example, who was responsible for that purchase, when it was performed, and how much is the total today? In order to support those queries, the data model stores key contextual information for each work item in the database. In addition to contextual information, the work items in the model also support many user-defined fields, allowing the model to be tailored to different application domains and purposes.

Automatic tracking of work items history: A history of any work item may be recorded over a period of time. As such, the automatic tracking of item history is the mechanism, together with the e-mail-based integration, that supports implementation of the different workflow modalities of the system. As each step, action item and its decisions are recorded, accountability is guaranteed.

Workflow Model—Business Logic

The business logic 120, shown in FIG. 1, defines the rules and general process involved in the presently disclosed change management tool. The business logic includes a process language 121, a process engine 123, a scheduler 124 and delegation of authority rules 122.

Organizational modeling and role-based workflow: In order to support the approval process, the system data and process model the organization structure with its roles and actors that fulfill those roles. The roles are defined by the process of the business; for example, roles may be project manager, resource deployment manager, coordinate, financial officer, CEO. Users are assigned as appropriate to the different roles. Each role may have one or more assignees.

An assignee has the ability to transfer or reassign users to different roles. For example, if an activity was assigned to a person in a role incorrectly, that person can transfer the item to a different person in that same role. When users are out of the office, they, or the administrator, can set an out-of-office approver for items for which they are approvers. The out-of-office approver gets copied on all emails and has permissions to make approvals and take other actions for the person for whom they are the designee.

Roles are also used for privilege and access control to various software features. For example, administrators can define the initial process for a business unit, and can configure the set of modules supported by the system.

Delegation of Authority Rules are a set of optional rules 122 that allow the system to assign an approver for an activity. Some rules are automatically enforced by the tool, while others are manually performed by convention. For example, the name of a role associated with an activity may include a monetary value. With that information, users know, for example, that if a non-conforming cost amount is over $100,000, the item must be routed to the CEO for approval.

E-mail-based notifications: The interaction of its system with the users is by means of Web pages and e-mail notifications. E-mails that include hyperlinks to Web pages describing the work items are sent to the users. Those hyperlinks lead to the system Web page where the work item is described, and where the user can take the appropriate action. For example, when approving a request or generating a report, the user is given a URL of that item history. After inspecting its values, she decides to approve it. Upon completion, the system notifies the interested parties associated with that work item; for example, the originator of the report and her manager.

Another important role of notifications is to remind users of open action items. With the help of the scheduler component 124, periodic notifications are sent whenever action items remain incomplete for an extended period of time.

Process language and engine: The process description language 121 and its expressiveness permits the presently described system to describe the workflow execution. The process engine 123 is described in more detail below.

Web-Based User Interface

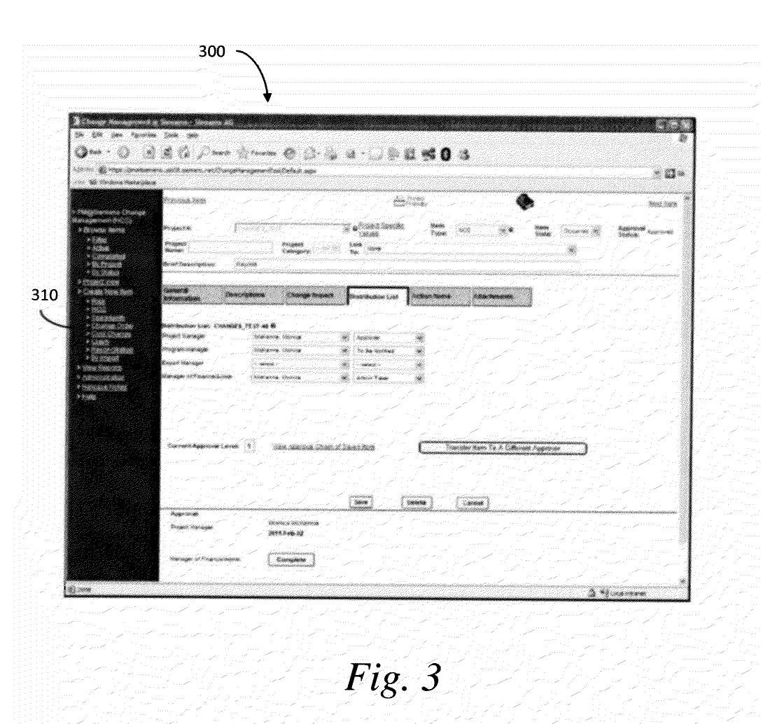

While e-mail is used as the main notification mechanism of the presently described approach, the interaction of the end users with the presently described change management tool is mainly Web-based; i.e., e-mail notifications contain links to Web pages such as the notification Web page 300 shown in FIG. 3, where users can log in and select, for example, among a list of approvers for a task.

The user interface task structure 140 is organized around the concept of “items.” For each item, a workflow template (or chain of approval) can be defined. When a new item is created, a new workflow instance is automatically started. Using the same user interface, users can verify existing and past items, and reports can be generated. Thus, the user interface design reflects an item-based structure, as shown on the left tab 310 of FIG. 3. By selecting various items, a user can verify his or her current status, and perform operations that browse items and create items.

The Web-based interface imparts its ubiquitous nature to the described system. From any Web client, approvals can be triggered, and the current status of an item can be verified.

Integration with Existing Enterprise Resource Planning Tools

Whereas the use of databases and the support for flexible workflow systems support the adaptability of the system to application domains not fully supported by existing enterprise resource planning systems, the integration with these tools is an important requirement. That is accomplished through the use of import and export filters 150, shown in FIG. 1. Those filters are implemented by each data type, and allow the automatic or semi-automatic synchronization of the presently described change management tool with existing enterprise resource planning tools. For every business unit or enterprise, filters are developed supporting the specific data format and reports. Hence, instead of developing a new system per business unit, the workflow engine and its work items can be integrated into existing tools.

Process Model

In the presently described approach, the workflow model is defined in terms of different activities or process steps. A process definition is known as a process workflow, an approval chain or a distribution list; those terms are used interchangeably. The main workflow parts are further described as follows.

Approval Chains: In the presently described model, a process template is called a process workflow or approval chain. Business units or enterprises where the tool is deployed define their own general approval chains within the constraints allowed. Each item that is created by the enterprise has a modified instance of that general approval chain.

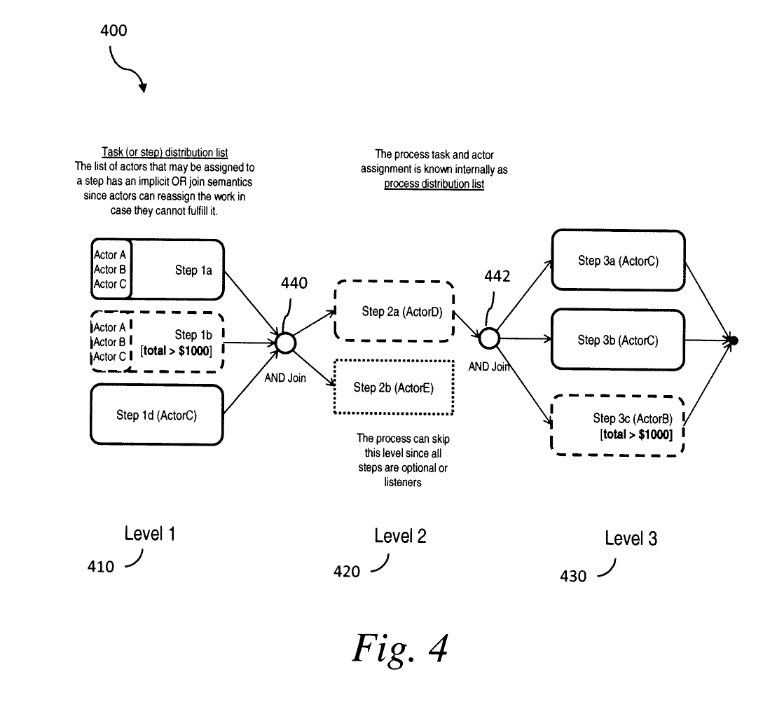

An example process workflow description 400 using a 3-level approval chain is shown in FIG. 4. An approval chain has one or more approval levels, and on each level, there can be one or more process steps configured according to different options, roles and actors. Once all steps in a level are completed, the workflow process moves to the next level. That repeats until the process workflow is finalized. Notifications are sent to approvers at the end of each level.

A process workflow is usually defined in terms of levels that comprise one or more steps (or activities). Steps are units of work assigned to people; they can be many things including: approve a claim, write a document, make a phone call, create a report, post a letter, etc. A workflow is usually complex, and prescribes inter-dependent steps. Steps organized in sequence indicate temporal precedence and dependence. Some steps can also be performed in parallel. Those are usually not dependent on one another, but may be dependent on previous steps, and may be required by steps in the future. The result is a sequence of parallel and sequential steps forming levels that are sewed together with synchronization points as shown, for example, in FIG. 4.

The approval chain 400 depicted in FIG. 4 has three levels 410, 420, 430. Each level is separated by an implicit synchronization point (AND join) 440, 442, which has an implicit approver. Different types of steps are supported. Those include 1) required steps with no pre-selected actor or responsible party (approver) (shown by solid outlines), 2) optional steps with no pre-selected responsible parties (shown by dashed outlines), and 3) listener steps with no pre-selected responsible parties (shown by dotted outlines). The model also supports cases similar to each of those cases, but having a pre-selected responsible party, where there is only one choice of responsible party for the step.

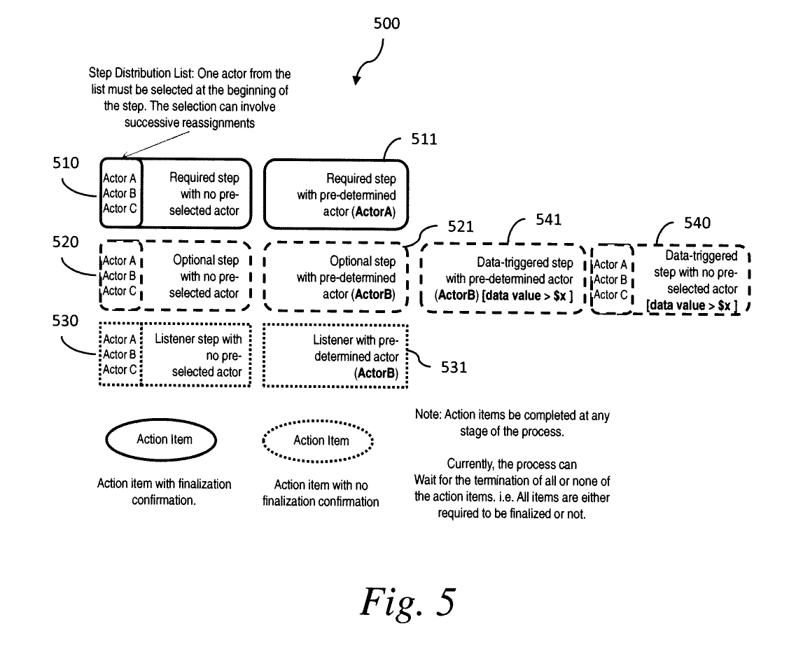

A table 500 of FIG. 5 shows types of steps and their variations. Note that a notation similar to that proposed by the Workflow Management Coalition (http://www.wfmc.org) is used, but with adaptations to express role allocation, optional, listener and action item activities.

A required step 510 with no pre-selected responsible party means that when a new item is created by a user, the creator must select an actor for that activity, from the list of options that they are given. The list of options is defined for the particular business unit. Users in a business unit are each assigned to 0 to n roles.

In an optional step 520 with no pre-selected responsible party, an item creator may or may not select an actor from a list of users to be in the approver role. For example, if the item creator knows that an item is related to a sales issue, the creator may add the sales manager to the approval chain for that item. For a case that is not related to a sales issue, the item creator may leave the role selection blank.

In a listener step 530, the selected actors get an email notifying them of the item, but the actors have no action to take on the item. Though the notified actors can view the item and can modify certain of the comment fields of the item, they have no approval or rejection authority. The step is for the actors' information only, and the actors do not impact the item from travelling further along the workflow.

Data-Triggered steps, such as step 540, can change from optional to required based on a data trigger. For example, if a non-conformance cost item total is over a specified value, the General Manager role might then become a required approver instead of an optional approver.

Each of the above step types may also be implemented with a pre-determined actor or responsible party, as illustrated by steps 511, 521, 531, 541. In those cases, only a single user, instead of a list of options, is presented to the item operator.

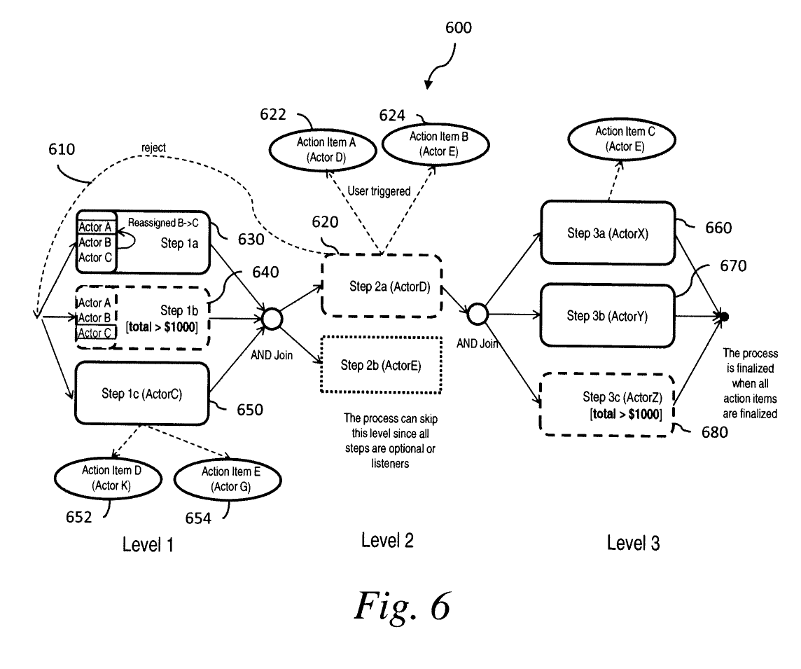

Any approver role, optional or not, can reject an item while the item is partially through the workflow. This resets the workflow process of the item and sends the item back to the creator. The history of why the item was rejected and records of the previous approvals are stored. As illustrated by the process 600 of FIG. 6, the dashed line 610 labeled “reject” shows a rejection workflow event being triggered. Once the item is rejected by actor D at 620, the item can then be started again on this approval chain, or left in the rejected state.

It is also possible for an approver, after receiving an item, to re-assign the task to a different approver, if the particular step is configured to allow reassignment. For example, at step 630, actor B reassigns its task to actor A.

Approvers or responsible parties are notified by email when their decision is required, receiving an email with a direct link to the item that needs their approval. Listeners are also notified this same way.

Action Items: In addition to providing for optional activities and the ability to reassign a task to another actor with a step, the presently described system and method also provide for the use of action items. Action items add an extra layer of flexibility to the approval chain by allowing actors to create new steps in the workflow. Action items can be started at any time in the approval process, from the creation of the item up until the item is completed. The business unit or enterprise can configure whether or not all action items for an item must be approved before the item is completed.

The following algorithm illustrates one example of a final approval of an item: if the next approval will result in the completion of an approval chain (so that all required approvals are made), check for open action items. If there are open action items, do not allow the final approval, and show an error message.

An action item is created when a command is received from an actor or responsible party creating the action item. The actor may be an approver, the item creator or any other authorized actor. The command includes a definition or description of the task to which the action item is directed and an identification of the responsible actor.

Action items can be assigned to any user within the enterprise who is registered in the system. Action items represent a much more free form than approval chain roles. The creation of action items also triggers e-mail notification to the assigned actor. As with other types of steps, e-mail reminders are periodically generated until the action item is followed up.

Combining the different process steps into chains of approval: The different types of steps previously discussed can be combined in different ways, representing a variety of flexible processes. The example process 600 of FIG. 6 illustrates one such combination.

Step 630 of Level 1 is a required step included in the template of the business unit or enterprise. An approver or responsible party must be selected from the menu when setting up the process. The selected responsible party may choose a different responsible party from the choices available for that role and re-assign the step to the new choice for responsible party.

Step 640 of Level 1 becomes a required step only if the item total is over a certain monetary value limit. Step 650 of Level 1 represents a required activity where the actor C is the only possible responsible party; i.e., no selection may be made by the process creator.

Either the creator of a process or its responsible parties may choose to start action items at any step in the workflow process. For example, actor C, the responsible party of the item of step 650, has created action item 652 and action item 654, to be completed by actor K and actor G, respectively.

The process workflow does not proceed to Level 2 until all steps at Level 1 have been completed. Action items may be configured so that they must be complete before the process advances to a next level, or may be configured to require completion before the overall process is completed.

Step 620 of Level 2 is an optional step. The responsible party (actor D) of step 620 created two action items 622, 624 assigned to actor D and actor E, respectively. As demonstrated by the creation of action items 622, 624 at Level 2, action items can be created at any time in the process. Since step 620 is optional, it is possible for a specific item to completely skip approval Level 2, going directly to Level 3.

In Level 3, two mandatory responsible parties are preselected in steps 660, 670 by the author of the template, and a third step 680 is optionally selected, except when the monetary value exceeds $1000.

Three main types of processes can be specified with the types of steps supported by the presently described system: procedural workflows, non-procedural workflows and blended workflows. These are discussed in more detail as follows.

Procedural Workflow: A procedural or structured workflow is defined as a set of pre-defined, well known, and usually required steps that users must undertake in order to perform their work. In particular, the model defines the approval phase, comprised of different levels of approval, with optionally multiple approvers per level (parallel or branching). The workflow moves to the next approval level only after all the approvals are received. Approvers can reset the process for an item by rejecting the item. In that case, the whole process restarts.

Once the approval is achieved in its potential different levels, the item status is updated, and the process moves to the next steps.

While the presently described change management tool is explained herein with reference to an approval process, the tool may be used for managing steps in any process performed by an enterprise. For example, the tool may be used to manage items as diverse as facilities changes, manufacturing process implementations or marketing projects.

Non procedural workflow: Non-procedural or unstructured workflow represents a set of unspecified actions involving people and artifacts that are undertaken in order to perform some piece of work.

The presently described system and method provide support for non-procedural workflow by supporting the free assignment of action items from one user to other users. The system automatically associates action items with work items, and records their evolution over time. In that mode, deadlines and notification policies can also be defined which allow the system to periodically check for the accomplishment of certain tasks.

From a user perspective, work item references are embedded in e-mails sent to the assigned users. For example, using an action item, John requests that Mary update a document relevant to a non-conformance item, specifying a deadline. The system then reminds Mary on a daily basis or as specified in the action item until she opens the change management tool and indicates that she has completed the requested action. When an action is completed, John receives a notification. The history of actions for the item is recorded in the database.

Blended procedural and non procedural work: In most cases, it is desirable and necessary to blend structured and unstructured workflow models. This blending allows procedural workflows to be modified, at runtime, in response to exceptions. For example, if for some reason, the person assigned to a step is not currently available, a user can reassign a step to another person. That is achieved by simply transferring the step to the new approver. While the item is going through its approval, approvers with permissions can add additional approvers, or change those approvers higher up in the chain as needed. The ability to create an action item may be used when an approver needs additional information from a third party. The ability to change an approver may also be used to set an ‘out-of-office’ flag for a person, so the replacement actor has approval rights for the out-of-office person.

Using the Tool

This section briefly describes the main functionality of the tool from the point of view of its users. Discussed are defining the workflow, generating reports, and handling exceptions.

Initial customization: The initial customization of the tool is done by examining the process of the business unit or enterprise for handing non-conformance costs and other project related items, such as opportunities, change orders, etc. Both the current process and the desired process must be described. The actual tool configuration takes only a small amount of training; however, figuring out the appropriate process is usually much harder and outside the scope of this document.

The administrator chooses which item types to track. For example, it may be appropriate to track only non-conformance costs or to track other item types as well. Other initial decisions include which fields are needed for reporting and how they are to be customized, whether or not to allow unstructured workflow action items, and the configuration of many other items such as distribution lists, roles, number of levels in an approval chain, etc. The administrator begins configuration using a Web page set up for a particular business unit or enterprise. Using the Web page, the administrator selects check boxes, chooses various items from drop downs, and imports comma separated files after first exporting them from other applications. Though the configuration can take several hours depending on the complexity of the process and organization, it is possible to do this configuration with only minimal training.

During the initial customization, a basic workflow scheme template, such as a template chain of approval, is set up for the business unit or enterprise. The template may, for example, define the roles and the levels of distribution of items for approval. It is set up in a general way, with users being assigned to one or more steps in the process. Each step has many attributes that can be set.

Regular use: This example uses a tool being used to define and track an approval process. A typical user of the tool who is responsible for creating items will enter the tool and create a specific item type. After specifying a project key, the user may then click a “lookup” button, which will pre-fill many of the fields of the item with the first match it finds in this project, looking first for items of the same type. This saves on data entry and helps keep data consistent within a project.

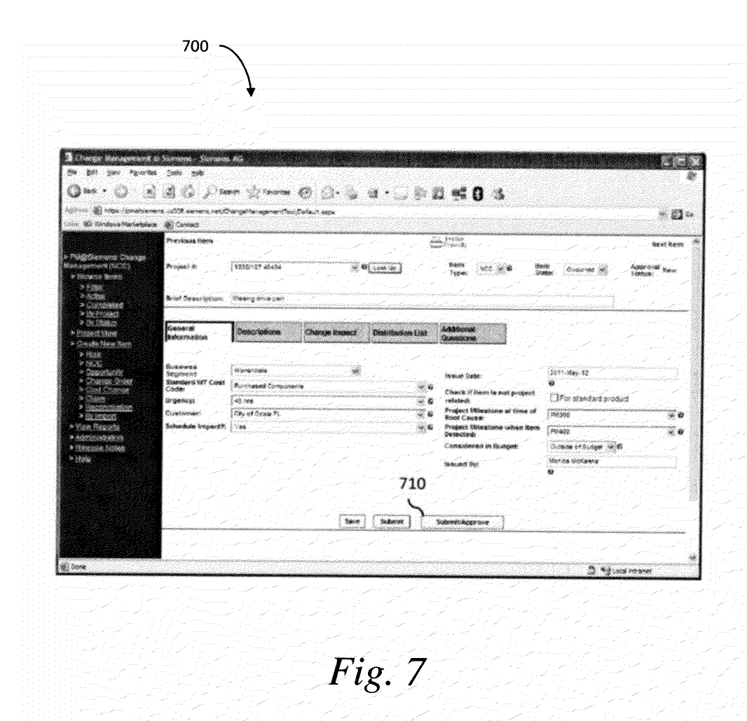

The creator then sets up an initial selection for the distribution of this item, defining approvers to whom the item must go to for approval. The screenshot 700 of FIG. 7 illustrates an interface for configuring the main attributes of a work item.

An e-mail is sent to the first approver, who then clicks on the link in the email to go into the tool, directly to the item referenced in the email. The user then adds text and possibly modifies the item (depending on administrator settings for his approval role), including possibly modifying future approvers. The user then clicks the “approve” button 710.

Once all approvers at the current level have approved the item, an e-mail is then sent to the next level of approvers, etc. At any stage, an approver may reject an item and enter the reason for the rejection. The item is then returned to the originator, who then has several options, including addressing the reason for the rejection and re-submitting the item.

Exception handling in active processes: Many types of deviations from regular use can be handled by the presently described approach. Some of the following example deviations may be handled without administrative intervention:

Reassign work to another person: depending on administrator settings for a given role, it is possible to re-route an item to a different approver by using a simple button that is directly on the approval screen.

Changes in the chain of approval: depending on settings, it is possible for a user to change approvers for approvers higher in the approval level than the user himself, or to add or remove approvers for levels higher than the user.

Rejection of work items: it is possible to reject an item, returning the item to its creator.

Action item creation: it is also possible to add an action item to the item, which is on an orthogonal approval process to that of the item itself. Depending on an administrator setting, it may not be possible to close an item until all related action items are complete.

Item cancelation: business unit or enterprise administrators can cancel and delete items. They can also make modifications such as changing the project key of the item via the administration Web pages, or archiving all items of a project, without actually contacting the tools administrator.

Evolving existing processes: As the process of a business unit or an enterprise matures, it is possible to modify the distribution chain, and then have the tool recompute the approval level of any pending items.

Using the administrator pages, the business unit or enterprise administrator can also add additional item types to the enterprise. The administrator can turn on features that had been turned off, such as the ability to add attachments. The administrator can unhide hidden fields such as “customer.” Each of these things can be done without involving a central tool administration, by modifying checkboxes and flags, etc., on the administrator Web pages.

Implementation Details

The presently described tool has been implemented as a Web application using an ASP.NET Web forms pattern framework. The application includes several libraries and is backed by a SQL Server database.

While many tools exist to support workflow and document management, a key advantage of the presently described tool is its customizability. An enterprise can customize the tool for its processes and its business without incurring additional development costs.

The subject tool additionally has a relatively low cost of ownership because the enterprise can remotely subscribe to and access the tool via the Web, requiring no local installation. Other factors contributing to the low cost of ownership include the use of a centrally located database, and good reliability.

Another advantage of the presently described system is the reflective analysis of the process that is required in configuring the tool. In order to first configure the tool, one must first understand the process being automated, which usually results in better awareness, planning and even some restructuring of the organization.

The following are several scenarios in which the tool may be successfully employed, showing the benefits of the different characteristics of the tool in supporting various processes.

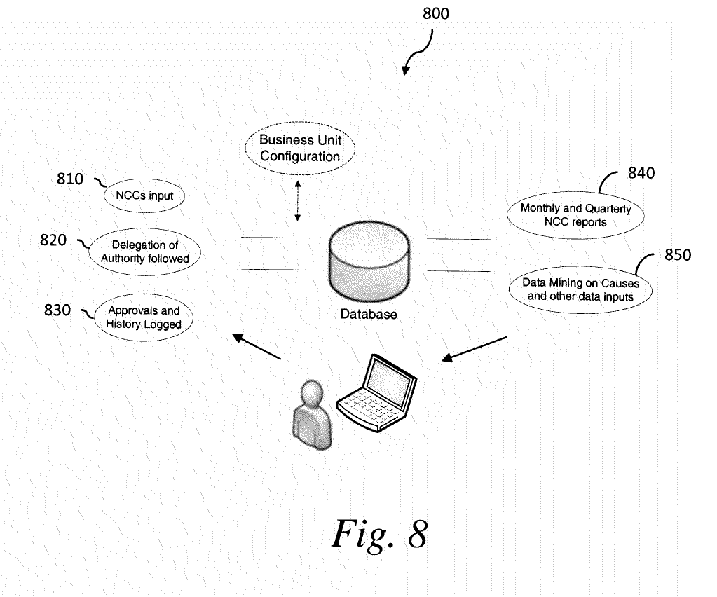

Case 1: Tracking of Non-Conformance Costs: The tool was originally designed to track non-conformance costs. As illustrated by the system 800 of FIG. 8, non-conformance costs are entered at 810, follow a standard approval chain 820, 830, and generate monthly and quarterly reports 840 per project and for the enterprise on the non-conformance cost level, and are able to show an audit trail for the approval of their non-conformance costs (NCCs) using data mining 850 or other means.

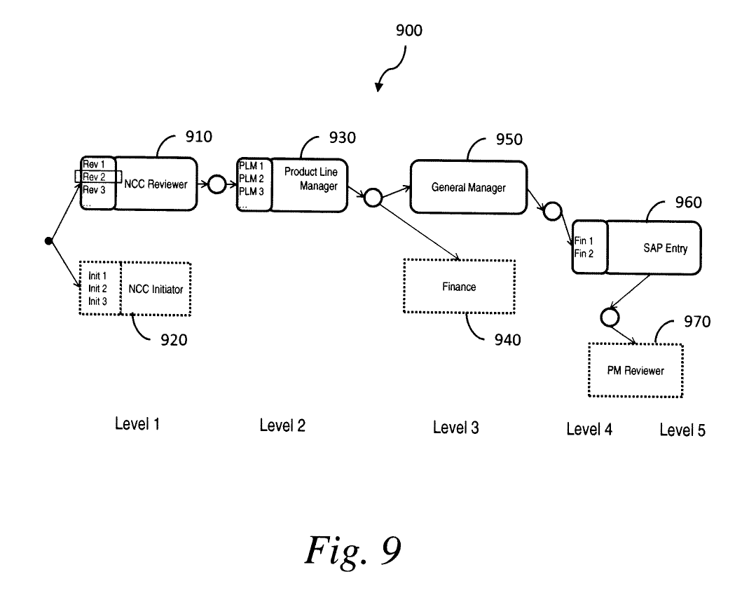

An exemplary enterprise workflow 900 is shown in FIG. 9. Enterprises using this scenario may configure their workflows quite differently; the workflow 900 is a representative example.

The first level approver is an “NCC Reviewer” 910. Also at the first level, the NCC initiator 920 is an optional listener, receiving notification email. That arrangement handles the case in which the person initiating the NCC is not the person who entered it into the tool. The initiator is informed that the item was entered and is now in process.

The second level approver is the “Product Line Manager” 930. The appropriate product line manager is chosen from a drop-down menu for the item.

Finance is then optionally informed as a listener at the third approval level 940, but does not approve or disprove an NCC. The general manager 950 always approves for this case.

Finally, the results are sent to an enterprise resource planning admin for final approval 960 and to update the enterprise resource planning system. The planning admin is responsible for verifying that all data is correct for the item before the ERP system can be updated at 970.

Case 2: Tracking of Projects: An enterprise may use multiple item types, not just non-conformance costs, and track its projects from order acceptance through completion within the presently described tool, reconciling on a regular basis with an enterprise resource planning system. That requires adding a project view especially for the enterprise, the addition of specific project tracking reports, along with key performance indicators calculation and reporting, and the ability to parse enterprise resource planning system reports for reconciliation. Administrators in an enterprise are able to enable or disable the project features as desired for their business unit needs.

Each enterprise may customize its workflow for its process; the following is a description of a representative use case.

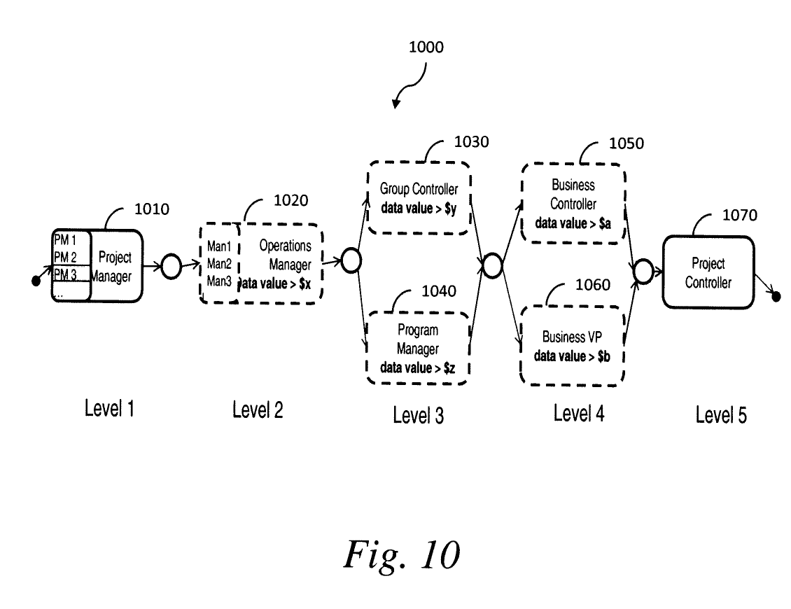

In the example project tracking item 1000 shown in FIG. 10, the Level one approver 1010 must always be chosen, and is the project manager for the project to which the item is related. Before approving, the project manager must verify that the item has been correctly entered with the correct monetary values, cause codes, and milestones, and that the approval chain going forward has the correct selections.

If the monetary value is greater than x (and the work item is a certain type, such as a non-conformance cost or a change order), then the operations manager becomes a required approver, and the appropriate operations manager for this project is chosen at block 1020. Once that approval is given, the item then goes on to Level 3.

If the monetary value is greater than y, the group controller becomes a required approver at 1030; otherwise the group controller can be optionally selected as an approver. If the monetary value is greater than a value z, then the program manager becomes a required approver at 1040. Once both the group controller and the program manager approve (if required), then the item goes to the next level. As with Level 3, monetary value and item type are used at Level 4 to determine if the approvers are required (in this case, the business controller 1050 and the business vice president 1060).

The Level 5 approver 1070 is always required; the project controller is responsible for entering the item into the enterprise resource planning system.

For a process instance with a low monetary value, the approval chain 1000 shown in FIG. 10 might be just two steps, the first approver 1010 (the project manager) and the Level 5 approver 1070 (the project controller).

Note that the initiator of the work item, the work item's creator, sets up the initial approval chain for the item. Once an item has been created for a specific project, the creator need only push a button, and the system will search for the “typical” approvers for this type of project. The approval chain therefore need only be verified by the creator.

The presently described system and method provides the flexibility to give some roles the ability to further modify the chain of approval. In the present example, the project manager is given that ability. For example, suppose the creator of an item did not explicitly assign the program manager since the monetary value for that item was low. Further suppose that this item is related to a project where the program manager has requested to be kept very closely informed. The project manager can add herself as an approver for that item at any time during the item life cycle.

Case 3: Tracking Customer Concessions: A business unit or enterprise may not be interested in tracking all non-conforming costs, but just those that were concessions to the customer. Such tracking does not require any changes to the presently described tool; instead, it is possible to use the tool by simply configuring it for that case.

Because customer concessions vary widely in approval and notification requirements, an approval chain for a customer concession includes not only typical specific role assignments (such as project manager, business manager, financial officer) in various approval levels, but also the use of some generic roles where a large number of different people may be entered in the role. The generic roles are labeled “level one approvers,” “level two approvers,” etc. In that way, a very large number of approvers may be entered in the system, and an item can be sent to a wide variety of people based on what the item is related to.

All approvers are allowed to re-assign, within their role, to someone else. For example, if a customer concession item was sent to an incorrect managing director, that director can re-assign her approval for that item to someone else. That is necessary in the case of customer concessions to make the process work smoothly, due to the large number of approver selections possible. The concession case also allows for the attachment of action items to the workflow process, where those action items are outside of the approval chain, except that they must be completed before the workflow can be completed.

Case 4: Blended Structured-Unstructured Workflow: The presently described tool may be used to track the evolution of non-conformance cost items, using both structured and unstructured workflows. That use takes advantage of the tool's ability to collect and report on additional information about items that may not available within an enterprise resource planning system. Those workflow aspects of the presently described system may be used even if the system is not used to track monetary amounts.

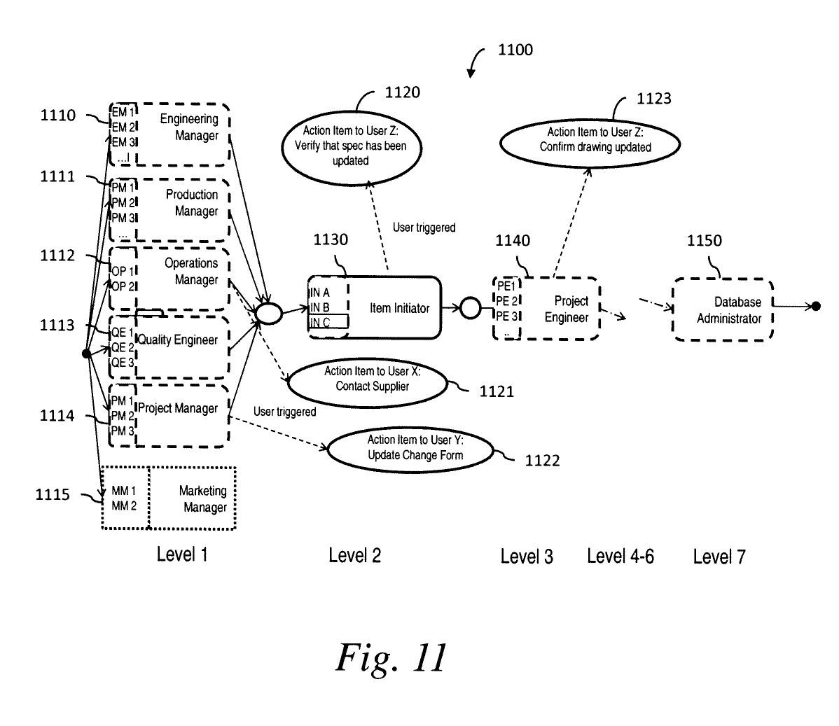

One such workflow 1100 is shown in FIG. 11. The enterprise approval chain starts out with many options, all optional, at the first level. These options include an engineering manager 1110, a production manager 1111, an operations manager 1112, a quality engineer 1113, and a product manager 1114. Also at the first level, the marketing manager 1115 can be informed, as a listener only.

Actors in any of those roles (as well as the item creator) can add action items. Some examples of action items in the illustrated enterprise are: to contact a supplier (action item 1121) for additional information for the item, to update a change form (action item 1122) that is used in the process of the enterprise to verify that a specification related to a project has been correctly updated as related to the non-conforming cost item, and to confirm (action item 1123) that an engineering drawing was updated as related to the non-conforming cost item. All of those actions fall outside the normal approval chain process, and may be assigned to users in the system that are not in the approval chain.

Returning to the approval levels, after all selected first level approvers have approved the item, the item goes the second level approver 1130. In the example workflow 1100 of FIG. 11 that approver is always the item initiator. This may be the creator, or a manager that asked that the item be created in the system. The approver 1130 can see any comments or actions that were added by any of the first level approvers. The approver 1130 verifies that the item has been correctly entered and that rest of the approval chain has been correctly specified as the approver feels is necessary.

Each of the subsequent roles 1140, 1150 in the approval chain 1100 are optional. Those approvers are all optionally selected, and each is defined in its own level; i.e., they are required to complete before the next activity may start. Roles such as project engineer 1140 and database administrator 1150 may become approvers on any given item. Any of those approvers may also initiate additional action items.

Case 5: Scheduling: The presently described change management tool is also a powerful scheduling tool, in which users utilize items to agree on date and place for an event such as a meeting. A user utilizes date fields of an item to propose an event date and a location field to propose a meeting place. The user then routes the item to various approvers to get approval for the event. That action produces automatic email notifications, sent for each approver. The tool also provides a centralized record of the approval history for the event date. Weekly reports are then generated from the tool, from which the actual schedule is easily derived. The unstructured workflow is also sometimes used in this case when actions outside of the structured workflow approval need to take place.

A workflow process used as a scheduling tool is similar to the example shown in FIG. 10, except that all steps other than the first level step 1010 are optional, and the last level 1070 has four choices of roles instead of just one. Action items created at any stage of the approval process may be used. The work item cannot be completed until all open action items are completed.

Action Items

A distinctive characteristic of the presently described process model is the ability to spawn action items at any point in time. Action items represent a very versatile feature in the presently disclosed system. They fulfill different roles in different processes, allowing users to create their own personalized workflow, and handle different ad-hoc situations. The following are examples of situations where action items may be effectively used:

Action items may be used to record the occurrence of corrective actions (of non-conformance costs, for example). The corrective actions may include: (a) providing additional training/documentation to new employees to reduce reoccurrence; (b) adding additional training sessions for all employees involved in the process; (c) updating documentation/drawings specific to the item; (d) updating process documentation, not always as related to this specific item but to the overall process (e) review procedures for calculating information; and (f) change the installation process or physical setup

Action items may be used as a record of actions taken with respect to a work item, such as: (a) contacting a supplier to inform the supplier about an item; (b) contacting a vendor about replacement/repair; (c) contacting a supplier to speed up delivery of a part; (d) Someone notices something on the item is not filled in correctly, and uses an action item to inform the person with rights to change the item that it is missing or incorrect (if the person noticing is not the approver, they can't reject the item, so this method provides a way to do this); and (e) asking an admin to have an item cancelled (happens in the event scheduling case only)—only admins can cancel items.

Action items may be used to obtain/request additional information about an item, such as (a) query sent to a user in the business unit asking a specific question about this item; (b) questions asked if this item is really correctly defined; and (c) questions asked if a process related to this item was followed or the status of that process.

Action items may be used to invoke processes outside the normal workflow of an item, such as: (a) start a separate billing issue investigation; (b) ask about hardware associated with the item; (c) assign a person to call another person to discuss something related to the item; and (d) ask someone to take action in another tool (also tracking things related to this item) such as in a fault report or billing tool.

Action items may be used to store additional information about an item and notify someone of places where information is located. For example: (a) Website links are added this way; (b) information about assignments to related tasks have been added this way; and (c) action items may be used to send someone information that a meeting had been held (and at the same time record the information that meeting was held) or that an email was sent.

Action items may be used to request someone, not in the normal workflow chain, to speed up the approval of a specific item. The action item may be a request to the approver to make approval of this item a high priority.

Action items may be used to inform someone, not on the normal workflow chain, about the status of a work item. The action item may be used just to make sure someone outside the normal workflow looks at this item

Method

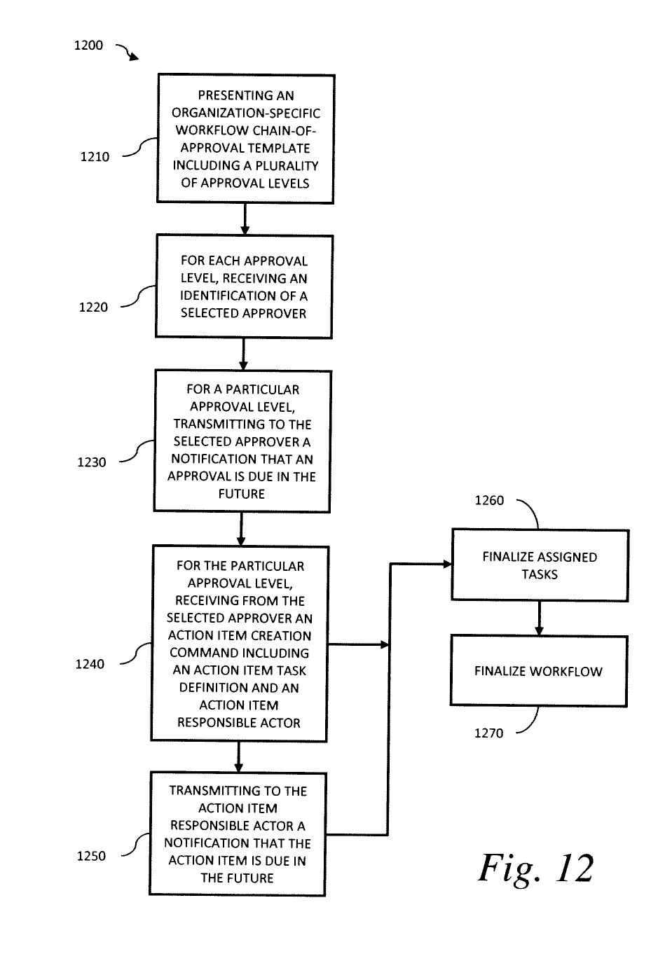

FIG. 12 is a flow chart illustrating a method 1200 for managing a process workflow in an enterprise. The method includes presenting, at block 1210, an organization-specific workflow template including a plurality of process levels, each process level comprising one or more process steps that may be required to be completed before the process workflow advances to a next process level. As noted above, the template is created for the enterprise or organization, and is reused for each workflow item to be managed. For each approval level, an identification of a selected responsible party by whom the process step must be completed is received at block 1220.

For a particular process step, a notification is transmitted to the selected responsible party that a process step is due to be completed in the future. The system makes use of email or any other familiar notification tool to notify the responsible party. For the particular process step, an action item creation command is received at block 1240 from the selected responsible party. The action item creation command includes an action item task definition and an action item responsible actor. Completion of the action item is required before the process workflow advances to a next process level. A notification is then transmitted at block 1250 to the action item responsible actor that the action item is due in the future.

After a process step or an action item is added, the system finalizes all tasks at block 1260, and finalizes the workflow at block 1270.

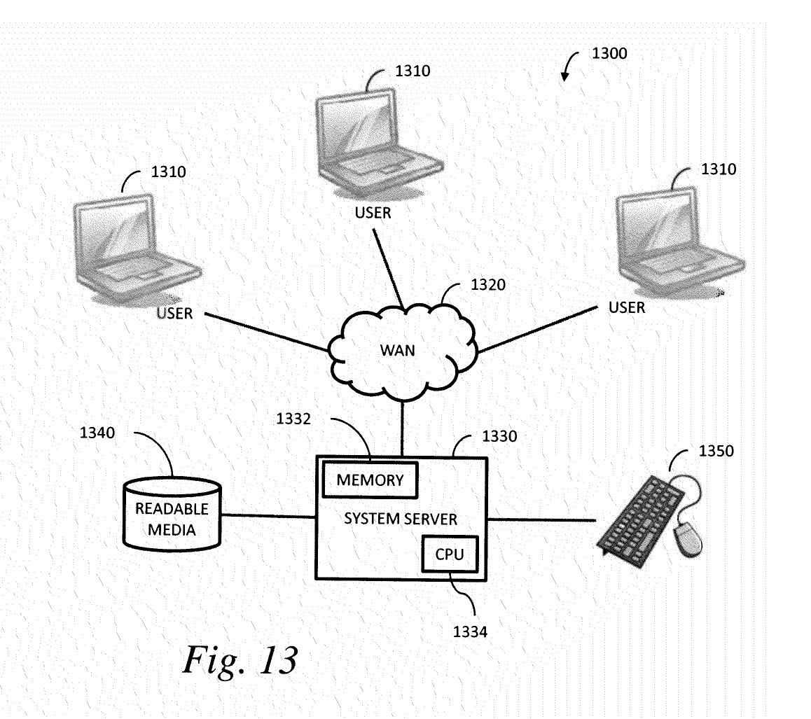

The elements of the methodology as described above may be implemented in a computer system comprising a single unit or a plurality of units linked by a network or a bus. An exemplary system 1300 is shown in FIG. 13.

The system server 1330 may be a mainframe computer, a desktop or laptop computer or any other device capable of processing data. The system server 1330 receives data from any number of data sources that may be connected to the computer, including a wide area data network 1320.

The system server 1330 includes a central processing unit (CPU) 1334 and a memory 1332. The server may be connected to an input and/or output device 1350. The input may be a mouse, network interface, touch screen, etc., and the output may be a liquid crystal display (LCD), cathode ray tube (CRT) display, printer, etc. Alternatively, commands containing input/output data may be passed via the network 1320. The server 1330 can be configured to operate and display information by using, e.g., the input and output devices 1350 to execute certain tasks.

The CPU 1334, when configured using software according to the present disclosure, includes modules that are configured for performing one or more methods for managing a workflow as discussed herein.

The memory 1332 may include a random access memory (RAM) and a read-only memory (ROM). The memory may also include removable media such as a disk drive, tape drive, memory card, etc., or a combination thereof. The RAM functions as a data memory that stores data used during execution of programs in the CPU 1334; the RAM is also used as a work area. The ROM functions as a program memory for storing a program executed in the CPU 1334. The program may reside on the ROM or on any other tangible or non-volatile computer-usable medium as computer readable instructions stored thereon for execution by the CPU or another processor to perform the methods of the invention. The ROM may also contain data for use by the program or other programs.

The above-described method may be implemented by program modules that are executed by a computer, as described above. Generally, program modules include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers and the like. The disclosure may also be employed in distributed computing environments, where tasks are performed by remote processing devices that are linked through a communications network. In a distributed computing environment, modules may be located in both local and remote memory storage devices.

An exemplary processing module for implementing the methodology above may be hardwired or stored in a separate memory that is read into a main memory of a processor or a plurality of processors from a computer readable medium such as a ROM or other type of hard magnetic drive, optical storage, tape or flash memory. In the case of a program stored in a memory media, execution of sequences of instructions in the module causes the processor to perform the process steps described herein. The embodiments of the present disclosure are not limited to any specific combination of hardware and software and the computer program code required to implement the foregoing can be developed by a person of ordinary skill in the art.

The term “computer-readable medium” as employed herein refers to any tangible machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. Such media excludes propagated signals, which are not tangible. Cached information is considered to be stored on a computer-readable medium. Common expedients of computer-readable media are well-known in the art and need not be described in detail here.

### CONCLUSION

A unique feature of the presently described system is its flexibility. In particular, the system supports a process model that allows users to cope with the variability of different workflow automation. The system supports action items, allowing users to spawn individual workflow tasks that are automatically monitored and managed by the system. A blended combination of structured and unstructured workflow models provides the flexibility necessary for the support of different processes, better supporting coordination activities within the organization.

A common problem in existing tools is rigidity: the ideas of prescription of steps versus description of steps. If a step is described, there is usually not much room for improvisation, change or freedom. Traditional systems were very rigid in the sense that they required all activities to be performed in the described order. The present approach is more flexible since it recognizes that work is not always necessarily done as described. A process description is, at its best, a prescription on how the work should be done. Hence, steps can be optional and transferrable to other people. The steps may also be not required if the data being considered is below certain value. The presently described technique supports a free flow format of interaction where assignees can generate and assign tasks to other people. The system simply monitors and records what is going on for auditing and communication proposes. The result is a combination of mandatory, optional and free flow activities (action items).

The foregoing detailed description is to be understood as being in every respect illustrative and exemplary, but not restrictive, and the scope of the disclosure herein is not to be determined from the description, but rather from the claims as interpreted according to the full breadth permitted by the patent laws. It is to be understood that various modifications will be implemented by those skilled in the art, without departing from the scope and spirit of the disclosure.

What is claimed is:

1. A method for managing a process workflow in an enterprise, the method comprising:
presenting, by a computer, an organization-specific workflow template including a plurality of process levels, each process level comprising one or more process steps that are required to be closed before the process workflow advances to a next process level;
for each process step, receiving, by the computer, an identification of a selected responsible party by whom the process step must be completed;
for a particular process step, transmitting to the selected responsible party a notification that a process step is due to be completed in the future;
for the particular process step, receiving from the selected responsible party an action item creation command including an action item task definition and an action item responsible actor, completion of the action item being required before the process workflow is closed; and
transmitting to the action item responsible actor a notification that the action item is due in the future.

2. A method as in claim 1, further comprising:
receiving from the action item responsible actor a notification that the action item is complete; and
transmitting to the selected responsible party the notification that the action item is complete.

3. A method as in claim 1, further comprising:
receiving from the action item responsible actor a notification that the action item is complete;
receiving notifications from all selected responsible parties that the process steps are completed for the particular level;
only after receiving notifications from all selected responsible parties that the process steps are completed for the particular level, and only after receiving from the action item responsible actor a notification that the action item is complete, transmitting, to a responsible party selected for completing a step in a subsequent level, a notification that a process step is due to be completed in the future.

4. A method as in claim 1, further comprising:
receiving from the action item responsible actor a request to transfer the action item to a second action item responsible actor;
transferring the action item to the second action item responsible actor;
transmitting to the second action item responsible actor a notification that the action item is due in the future.

5. A method as in claim 1, further comprising:
receiving from the selected responsible party a request to substitute a second selected responsible party for the selected responsible party;
substituting the second selected responsible party for the selected responsible party; and
transmitting to the second selected responsible party a notification that the process step is due in the future.

6. A method as in claim 1, wherein, for the particular process step, the receiving an identification of the selected responsible party and the transmitting to the selected responsible party a notification that the process step is due to be completed in the future are contingent on whether a value of an item addressed by the workflow exceeds a predetermined amount.

7. A method as in claim 1, wherein the organization-specific workflow template is presented on a Web interface.

8. A method as in claim 1, wherein the action item task definition comprises a request for additional information from the action item responsible actor.

9. A method as in claim 1, wherein the process workflow comprises an approval of a non-conformance cost within the organization.

10. A method as in claim 1, further comprising:
receiving from the selected responsible party a rejection of the item; and
in response to receiving the rejection, returning the item to a first process level.

11. A non-transitory computer-usable medium having computer readable instructions stored thereon for execution by a processor to perform a method for managing a process workflow in an enterprise, the method comprising:
presenting an organization-specific workflow template including a plurality of process levels, each process level comprising one or more process steps that are required to be closed before the process workflow advances to a next process level;
for each process step, receiving an identification of a selected responsible party by whom the process step must be completed;
for a particular process step, transmitting to the selected responsible party a notification that a process step is due to be completed in the future;
for the particular process step, receiving from the selected responsible party an action item creation command including an action item task definition and an action item responsible actor, completion of the action item being required before the process workflow is closed; and
transmitting to the action item responsible actor a notification that the action item is due in the future.

12. A non-transitory computer-usable medium as in claim 11, the method further comprising:
receiving from the action item responsible actor a notification that the action item is complete; and
transmitting to the selected responsible party the notification that the action item is complete.

13. A non-transitory computer-usable medium as in claim 11, the method further comprising:
receiving from the action item responsible actor a notification that the action item is complete;
receiving notifications from all selected responsible parties that the process steps are completed for the particular level;
only after receiving notifications from all selected responsible parties that the process steps are completed for the particular level, and only after receiving from the action item responsible actor a notification that the action item is complete, transmitting, to a responsible party selected for completing a step in a subsequent level, a notification that a process step is due to be completed in the future.

14. A non-transitory computer-usable medium as in claim 11, the method further comprising:
receiving from the action item responsible actor a request to transfer the action item to a second action item responsible actor;
transferring the action item to the second action item responsible actor;
transmitting to the second action item responsible actor a notification that the action item is due in the future.

15. A non-transitory computer-usable medium as in claim 11, the method further comprising:
receiving from the selected responsible party a request to substitute a second selected responsible party for the selected responsible party;
substituting the second selected responsible party for the selected responsible party; and
transmitting to the second selected responsible party a notification that the process step is due in the future.

16. A non-transitory computer-usable medium as in claim 11, wherein, for the particular process step, the receiving an identification of the selected responsible party and the transmitting to the selected responsible party a notification that the process step is due to be completed in the future are contingent on whether a value of an item addressed by the workflow exceeds a predetermined amount.

17. A non-transitory computer-usable medium as in claim 11, wherein the organization-specific workflow template is presented on a Web interface.

18. A non-transitory computer-usable medium as in claim 11, wherein the action item task definition comprises a request for additional information from the action item responsible actor.

19. A non-transitory computer-usable medium as in claim 11, wherein the process workflow comprises an approval of a non-conformance cost within the organization.

20. A non-transitory computer-usable medium as in claim 11, the method further comprising:
receiving from the selected responsible party a rejection of the item; and
in response to receiving the rejection, returning the item to a first process level.
